(19) United States
(12) Patent Application Publication
(10) Pub. No.: US 2009/0066622 A1
(43) Pub. Date: Mar. 12, 2009

(54) LIQUID CRYSTAL DISPLAY DEVICE

(75) Inventors: Chih-hsiang Yang, Hsin-Chu City (TW); Chun-fan Chung, Hsin-Chu City (TW); Sheng-kai Hsu, Hsin-Chu City (TW)

Correspondence Address: KIRTON AND MCCONKIE, 60 EAST SOUTH TEMPLE,, SUITE 1800, SALT LAKE CITY, UT, 84111, US

(73) Assignee: AU OPTRONICS CORP., Hsin-Chu City (TW)

(21) Appl. No.: 12/043,430

(22) Filed: Mar. 6, 2008

(30) Foreign Application Priority Data
Sep. 11, 2007 (TW) 096133886

(51) Int. Cl. G09G 3/36

(52) U.S. Cl. 345/89

(57) ABSTRACT

A liquid crystal display device includes a liquid crystal panel having a plurality of pixel units for displaying images, a timing controller for generating image data, a reference voltage generator for generating a reference voltage group, a plurality of voltage dividers, and a plurality of converters. Each voltage divider is used for dividing the reference voltage group into a respective level voltage group. The converters are used for converting the image data into a plurality of data signal voltages on the basis of the level voltage groups. Each pixel unit us used for showing various grey levels based on the data signal voltages.

### RELATED APPLICATIONS

This application claims priority to Taiwan Patent Application Serial Number 96133886, filed Sep. 11, 2007, which is herein incorporated by reference.

### BACKGROUND OF THE INVENTION

1. Field of the Invention

The present invention relates to a liquid crystal display, and more specifically, to a liquid crystal display capable of outputting different analogy data signal voltages in response to a digital image data, to driving respective pixel units.

2. Description of the Related Art

With a rapid development of monitor types, novel and colorful monitors with high resolution, e.g., liquid crystal display (LCD) devices, are indispensable components used in various electronic products such as monitors for notebook computers, personal digital assistants (PDAs), digital cameras, and projectors. The demand for the novelty and colorful monitors has increased tremendously.

Conventionally, upon receiving clock signal from the timing controller, a plurality of gate driver generate scan signals and provide these scan signals to the liquid crystal panel via the scan lines. Meanwhile, the plurality of source drivers deliver the digital image data to the liquid crystal panel via the data lines, in response to the clock signals from the timing controller.

Referring to FIG. 1 showing a Level-Voltage (L-V) curve, where the horizontal axis represents digital image data values, the vertical axis on the left side of the graph represents the level voltage group V_{GMA1}-V_{GMA18}, the vertical axis on the right side of the graph represents gray levels, and AVDD represents analogy supply voltage of the source driver. When receiving digital image data, digital-to-analog converters in the source driver convert the digital image data into analogy data signal voltages based on a gamma voltage group and the L-V curve, so that the analogy data signal voltages correspond to various grey levels. As a result, the pixel units show an image based on the digital image data signal and common voltage in response to the scan signal. However, for upgrading display quality and increasing flexibility of color calibration, the source driver needs to output different analogy data signal voltages, in response to a digital image data, to drive pixels.

### SUMMARY OF THE INVENTION

Accordingly, the present invention is directed to a liquid crystal display capable of outputting different analogy data signal voltages in response to a digital image data, to driving respective pixel units.

In one aspect of the present invention, a liquid crystal display device includes a liquid crystal panel having a plurality of pixel units for displaying images, a timing controller for generating image data, a reference voltage generator for generating a reference voltage group, a plurality of voltage dividers, and a plurality of converters. Each voltage divider is used for dividing the reference voltage group into a respective level voltage group. The converters are used for converting the image data into a plurality of data signal voltages on the basis of the level voltage groups. Each pixel unit us used for showing various grey levels based on the data signal voltages.

In one embodiment of the present invention, each voltage divider consists of a plurality of resistors connected in serial.

In another embodiment of the present invention, the liquid crystal display device further comprises a multiplexer. The plurality of converters comprise a plurality of first polarity digital-to-analog converters and a plurality of second polarity digital-to-analog converters, the multiplexers switches to output the data signal voltages from the first polarity digital-to-analog converters or the second polarity digital-to-analog converters based on a polarity signal.

In another aspect of the present invention, a liquid crystal display device comprises a timing controller for generating image data, a plurality of reference voltage generators for generating a plurality of reference voltage groups, a voltage divider for dividing the plurality reference voltage groups into a plurality of level voltage groups, a plurality of converters for converting the image data into a plurality of data signal voltages on the basis of the plurality of level voltage groups, and a liquid crystal panel having a plurality of pixel units, each pixel unit for showing various grey levels based on the data signal voltages.

In one embodiment of the present invention, each voltage divider consists of a plurality of resistors connected in serial.

In another embodiment of the present invention, the liquid crystal display device further comprises a multiplexer. The plurality of converters comprise a plurality of first polarity digital-to-analog converters and a plurality of second polarity digital-to-analog converters, the multiplexers switches to output the data signal voltages from the first polarity digital-to-analog converters or the second polarity digital-to-analog converters based on a polarity signal.

According to the present invention, a liquid crystal display device comprises a reference voltage generator for generating a reference voltage group, a memory for storing a plurality of lookup tables, each of which lookup table records a respective relationship between the digital image data and a shift image data, a control unit for converting the image data into the plurality of shift image data based on the plurality of lookup tables, a plurality of converters for converting the plurality of shift image data into a plurality of data signal voltages on the basis of the reference voltage group and a liquid crystal panel having a plurality of pixel units, each pixel unit for showing various grey levels based on the data signal voltages.

In one embodiment of the present invention, each voltage divider consists of a plurality of resistors connected in serial.

In another embodiment of the present invention, the liquid crystal display device further comprises a multiplexer. The plurality of converters comprise a plurality of first polarity digital-to-analog converters and a plurality of second polarity digital-to-analog converters, the multiplexers switches to output the data signal voltages from the first polarity digital-to-analog converters or the second polarity digital-to-analog converters based on a polarity signal.

These and other objectives of the present invention will become apparent to those of ordinary skill in the art after reading the following detailed description of the preferred embodiment that is illustrated in the various figures and drawings.

### BRIEF DESCRIPTION OF THE DRAWINGS

FIG. 1 shows a Level-Voltage (L-V) curve.

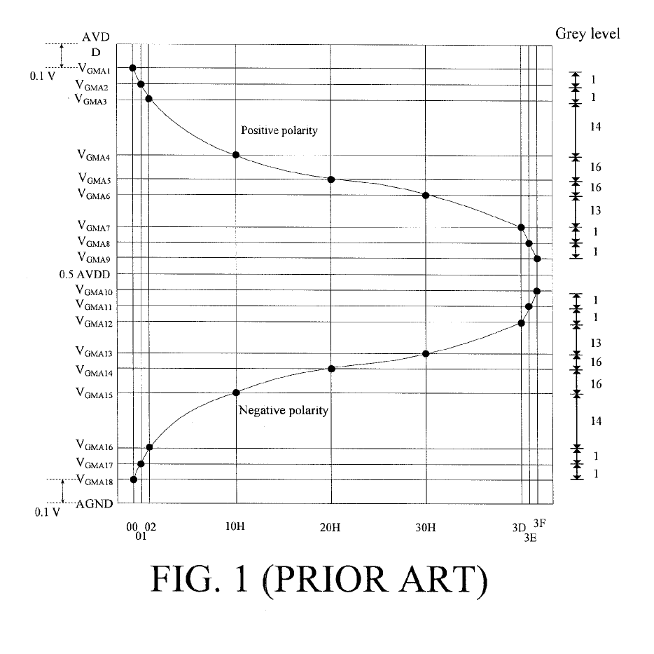

FIG. 2 shows a block diagram of a liquid crystal display device according to a first embodiment of the present invention.

FIG. 3 illustrates a block diagram of a source driver shown in FIG. 2.

FIG. 4 shows a level-voltage curve according to an exemplary example of the present invention.

FIG. 5 illustrates a block diagram of the liquid crystal display device according to the second embodiment of the present invention.

FIG. 6A depicts a block diagram of a first embodiment of the source driver shown in FIG. 5.

FIG. 6B illustrates a block diagram of a second embodiment of the source driver shown in FIG. 5.

FIG. 7 illustrates a block diagram of liquid crystal display device according to a third embodiment of the present invention

FIG. 8 illustrates a block diagram of the source driver shown in FIG. 7.

### DETAILED DESCRIPTION OF THE INVENTION

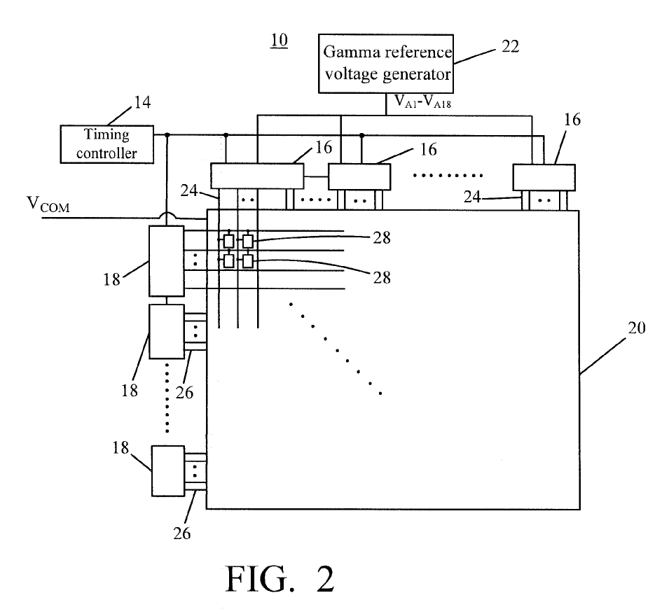

Referring to FIG. 2 showing a block diagram of a liquid crystal display device according to a first embodiment of the present invention, a liquid crystal display device 10 comprises a timing controller 14, a plurality of source drivers 16, a plurality of gate drivers 18, a gamma reference voltage generator 22, and a liquid crystal panel 20 having a plurality of pixel units 28. Upon receiving clock signal from the timing controller 14, the plurality of gate drivers 18 generate scan signal to the liquid crystal panel 20 via the scan lines 26. Meanwhile, the plurality of source drivers 16 deliver digital image data to the liquid crystal panel 20 via the data lines 24, in response to the clock signal. As a result, the pixel units 28 show an image based on the digital image data signal and common voltage V_{COM} in response to the scan signal.

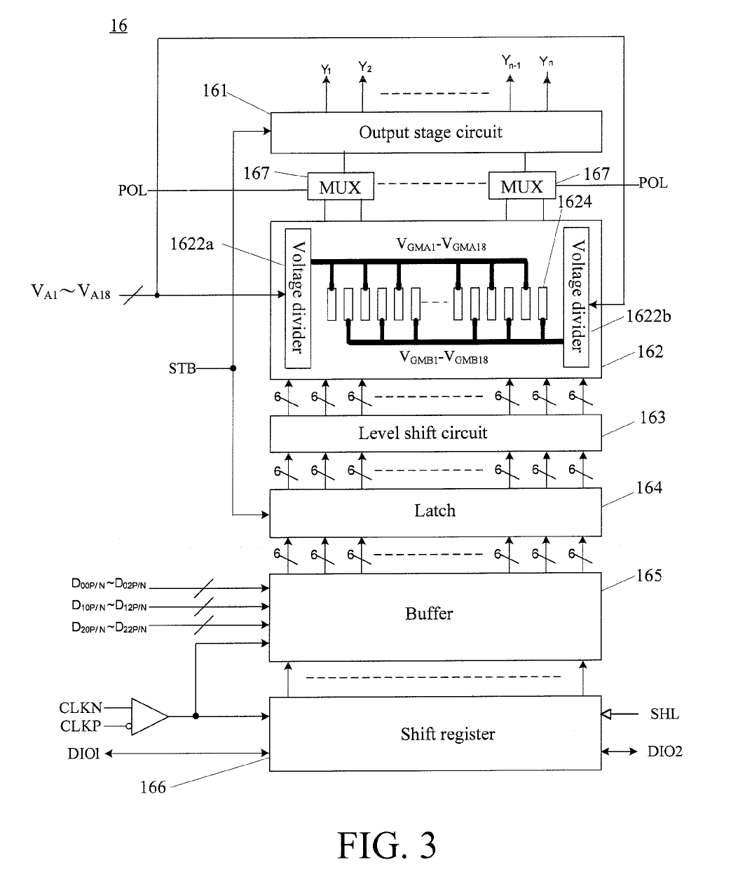

Referring to FIG. 3 illustrating a block diagram of a source driver 16 shown in FIG. 2, the source driver 16 comprises an output stage circuit (e.g., operating amplifier) 161, a converter 162, a level shift circuit 163, a latch 164, a buffer 165, a shift register 166, and a plurality of multiplexers 167. The timing controller 14 sends data signals D00P/N-D02P/N, D10P/N-D102P/N, D20P/N-D22P/N to the buffer 165 through a bus. The clock signal CLKP/N is fed to the shift register 166 and the buffer 165. When the shift register 166 enables to read data signal in response to enabling signal DIO1, the enabling signal DIO2 is then fed into the following stage source driver 16. The shift direction control signal SHL is used for controlling a shift direction. The control signal STB is fed to the latch 164 and the output stage circuit 161. While the control signal is at a rising edge, video data stream is delivered from the buffer 165 to the latch 164; alternatively, while the control signal is at a falling edge, the video data stream is fed to the pixel units 28 of the liquid crystal panel 20 via the output stage circuit 161.

The converter 162 comprises a plurality of voltage dividers 1622 and a plurality of digital-to-analog converters (DACs) 1624. For simplicity, only two voltage dividers 1622a, 1622b are drawn in FIG. 3, and three or more voltage dividers are also allowable in other embodiments. Each voltage divider 1622a, 1622b consists of a plurality of resistors connected in serial. It is noted that outputs of the first voltage divider 1622a are different from those of the second voltage divider 1622b; in other words, even though both voltage divider 1622a, 1622b are fed by an identical reference voltage group V_{A1}-V_{A18} from the gamma reference voltage generator 22, outputs of the first voltage divider 1622a are the first level voltage group V_{GMA1}-V_{GMA18}, while outputs of the second voltage divider 1622b are the second level voltage group V_{GMB1}-V_{GMB18}.

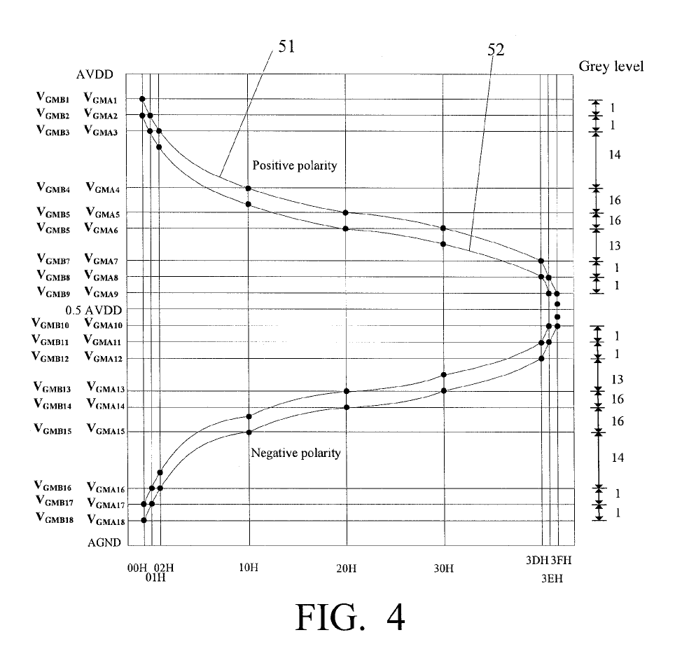

Referring to FIG. 3 in conjunction to FIG. 4 showing a level-voltage curve according to an exemplary example of the present invention, where the horizontal axis represents digital image data values, the vertical axis on the left side of the graph represents the first level voltage group V_{GMA1}-V_{GMA18} and the second level voltage group V_{GMB1}-V_{GMB18}, the vertical axis on the right side of the graph represents gray level, and AVDD represents analogy supply voltage of the source driver. The DACs 1624 (i.e. first polarity DACs) electrically connected to the first level voltage group V_{GMA1}-V_{GMA18} converts the digital image data into analogy data signal voltage based on L-V curve 51, while the DACs 1624 (i.e. second polarity DACs) electrically connected to the second level voltage group V_{GMB1}-V_{GMB18} converts the digital image data into analogy data signal voltage based on L-V curve 52. As shown in FIG. 4, the digital image data is converted two different analogy data signal voltages depending on different L-V curves 51, 52. Thereafter, the multiplexers 167 switches to output the analogy data signal voltages from the first polarity DACs or the second polarity DACs based on a polarity signal POL. Finally, the pixel units 28 of the liquid crystal panel 20 displays various grey levels based on analogy data signal voltages from the DACs 1624 through channels Y₁-Yₙ of the source drivers 16.

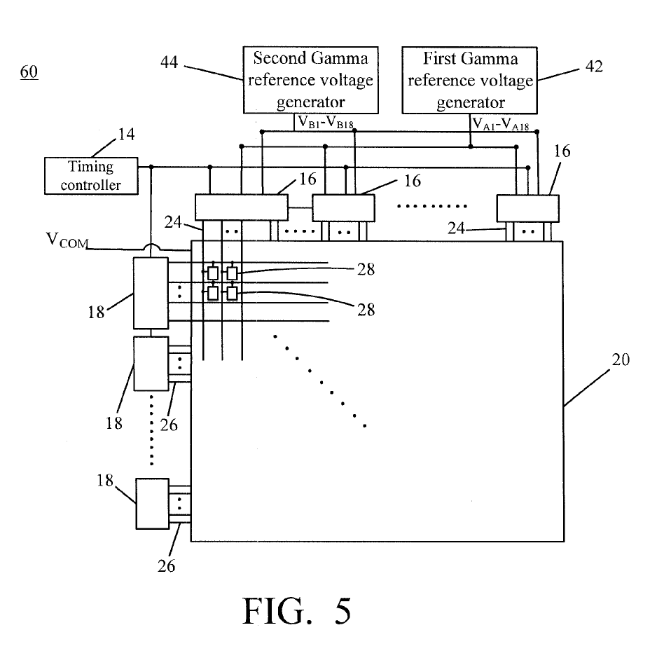

With reference to FIG. 5 illustrating a block diagram of the liquid crystal display device according to the second embodiment of the present invention, the liquid crystal display device 60 comprises a timing controller 14, a plurality of source drivers 16, a plurality of gate drivers 18, a first gamma reference voltage generator 42, a second gamma reference voltage generator 44, and a liquid crystal panel 20 having a plurality of pixel units 28. Upon receiving clock signal from the timing controller 14, the plurality of gate drivers 18 generate scan signal to the liquid crystal panel 20 via the scan lines 26. Meanwhile, the plurality of source drivers 16 deliver digital image data to the liquid crystal panel 20 via the data lines 24, in response to the clock signal from the timing controller 14. As a result, the pixel units 28 show an image based on the digital image data signal and common voltage V_{COM} in response to the scan signal.

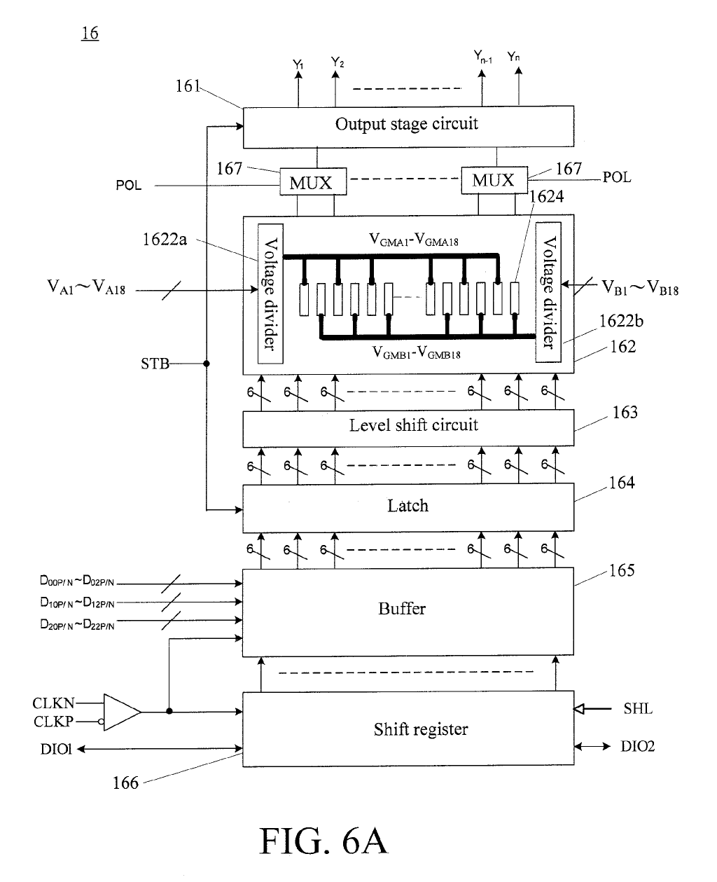

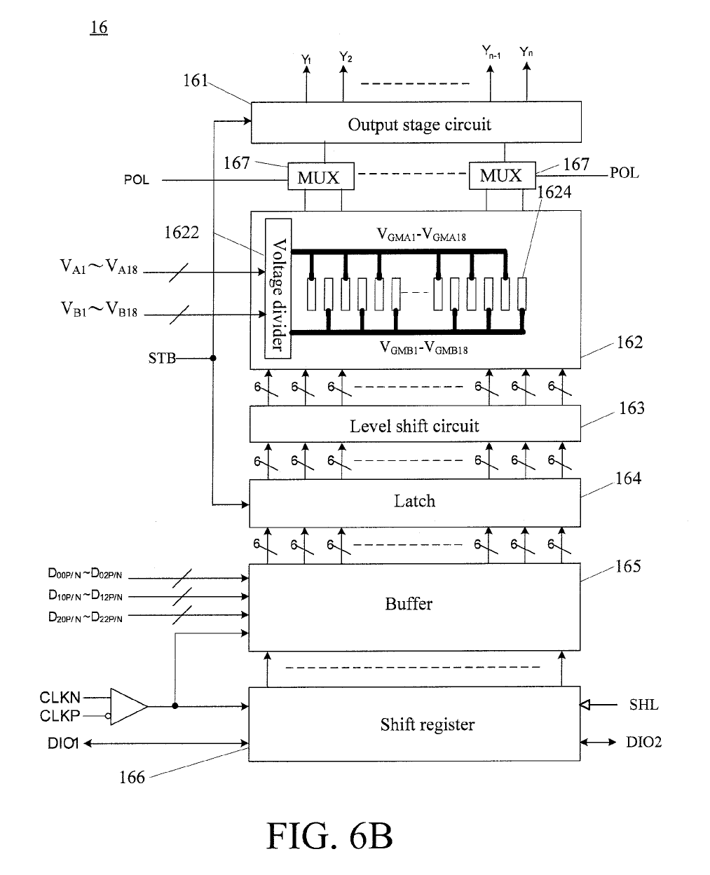

Referring FIG. 6A depicting a block diagram of a first embodiment of a source driver shown in FIG. 5. The source driver 16 comprises an output stage circuit 161, a converter 162, a level shift circuit 163, a latch 164, a buffer 165, a shift register 166, and a plurality of multiplexers 167. It is noted that, for simplicity, elements in FIG. 6 that have the same function as that illustrated in FIG. 3 are provided with the same item numbers as those used in FIG. 3. The converter 162 comprises a plurality of voltage dividers 1622 and a plurality of DACs 1624. For simplicity, only two voltage dividers 1622a, 1622b are drawn in FIG. 6, three or more voltage dividers are also allowable in other embodiments. Each voltage divider 1622a, 1622b is consisting of a plurality of resistors connected in serial. It is noted that outputs of the first voltage divider 1622a are different from those of the second voltage divider 1622b; in other words, the first voltage divider 1622a is fed by a reference voltage group V_{A1}-V_{A18} from the first gamma reference voltage generator 42, and outputs the first level voltage group V_{GMA1}-V_{GMA18}, while the second voltage divider 1622b is fed by a reference voltage group V_{B1}-V_{B18} from the second gamma reference voltage generator 44, and outputs the second level voltage group V_{GMB1}-V_{GMB18}. The DACs 1624 (i.e. first polarity DACs) electrically connected to the first level voltage group V_{GMA1}-V_{GMA18} converts the digital image data into analogy data signal voltage based on L-V curve 51, while the DACs 1624 (i.e. second polarity DACs) electrically connected to the second level voltage group V_{GMB1}-V_{GMB18} converts the digital image data into analogy data signal voltage based on L-V curve 52. As shown in FIG. 4, the digital image data is converted two different analogy data signal voltages depending on different L-V curves 51, 52. Thereafter, the multiplexers 167 switches to output the analogy data signal voltages from the first polarity DACs or the second polarity DACs based on a polarity signal POL. Finally, the pixel units 28 of the liquid crystal panel 20 displays various grey levels based on analogy data signal voltages from the DACs 1624 through channels Y₁-Yₙ of the source drivers 16.

Referring to FIG. 6B illustrating a block diagram of a second embodiment source driver, the source 16 in FIG. 6B comprises a voltage divider 1622. The only voltage divider 1622 is fed by a reference voltage group V_{A1}-V_{A18} from the first gamma reference voltage generator 42, and outputs the first level voltage group V_{GMA1}-V_{GMA18} Also, the only voltage divider 1622 is fed by a reference voltage group V_{B1}-V_{B18} from the second gamma reference voltage generator 44, and outputs the second level voltage group V_{GMB1}-V_{GMB18}. Except the voltage divider 1622, operations of all elements in the source drivers shown in FIG. 6A and FIG. 6B are identical.

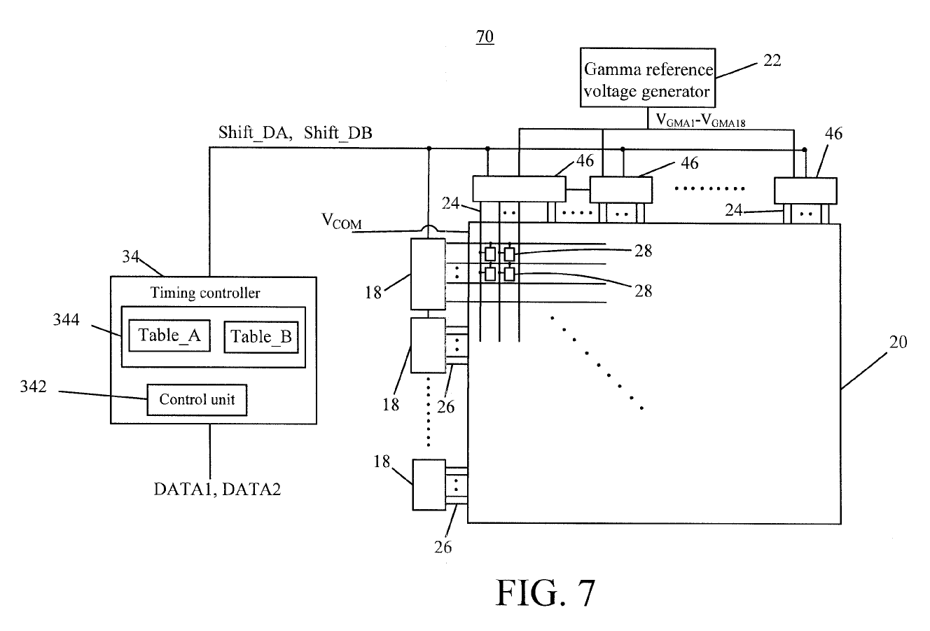

Referring to FIG. 7 illustrating a block diagram of liquid crystal display device according to a third embodiment of the present invention, the liquid crystal display device 70 comprises a timing controller 34, a plurality of source drivers 46, a plurality of gate drivers 18, a gamma reference voltage generator 22, and a liquid crystal panel 20 having a plurality of pixel units 28. Upon receiving clock signal from the timing controller 34, the plurality of gate drivers 18 generate scan signal to the liquid crystal panel 20 via the scan lines 26. Meanwhile, the plurality of source drivers 46 deliver digital image data to the liquid crystal panel 20 via the data lines 24, in response to the clock signal from the timing controller 34. As a result, the pixel units 28 show an image based on the digital image data signal and common voltage V_{COM} in response to the scan signal.

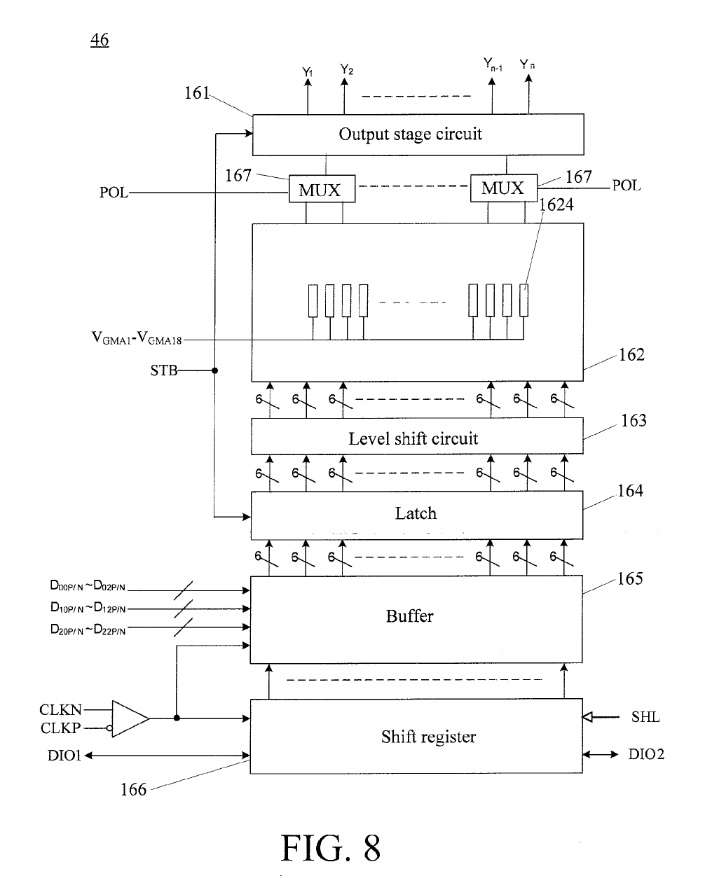

Referring to FIGS. 5 and 7 in conjunction with FIG. 8 illustrating a block diagram of source driver 46 shown in FIG. 7, the timing controller 34 comprises a control unit 342 and a memory 344. It is noted that, for simplicity, elements in FIG. 8 that have the same function as that illustrated in FIG. 3 are provided with the same item numbers as those used in FIG. 3. The memory 344 saves a plurality of lookup tables, each of which records a relationship between the digital image data and shift image data. The control unit 342 is used for converting the digital image data into a plurality of shift image data based on the plurality of lookup tables. The converter 162 comprises a plurality of DACs 1624 for converting the digital image data into analogy data signal voltage based on the level voltage group V_{GMA1}-V_{GMA18} from the gamma reference voltage generator 22. Referring to FIG. 7, and taking negative polarity as an example, when the digital image data DATA1 is received by the timing controller 34, the control unit 342 converts the digital image data DATA1 as shift image data Shift_DA of 30H based on the lookup table Table_A, and converts the digital image data DATA1 as shift image data Shift_DB of 20H based on the lookup table Table_B. When the digital image data DATA2 is received by the timing controller 34, the control unit 342 converts the digital image data DATA2 as shift image data Shift_DA of 02H based on the lookup table Table_A, and converts the digital image data DATA2 as shift image data Shift_DB of 01H based on the lookup table Table_B. Subsequently, the DACs 1624 converts the shift image data Shift_DA of 30H, 02H into level voltages V_{GMA13}, V_{GMA16} according to the reference voltage group V_{GMA1}-V_{GMA18}, and then outputs as analogy data signal voltage via the output stage circuit 161. Similarly, the DACs 1624 converts the shift image data Shift_DB of 20H, 01H into level voltages V_{GMA14}, V_{GMA17} according to the reference voltage group V_{GMA1}-V_{GMA18}, and then outputs as analogy data signal voltage via the output stage circuit 161. As a result, by using above-mentioned mechanism, the source driver 46 outputs different analogy data signal voltages corresponding to a digital image data.

In this embodiment, the source driver 46 further comprises a plurality of multiplexers 167 switching to output the analogy data signal voltages from the first polarity DACs (i.e. the DACs coupled to the shift image data Shift_DA) or the second polarity DACs (i.e. the DACs coupled to the shift image data Shift_DB) based on a polarity signal POL. Finally, the pixel units 28 of the liquid crystal panel 20 displays various grey levels based on analogy data signal voltages from the DACs 1624 through the source drivers 46.

While the invention has been described by way of example and in terms of the preferred embodiment, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A liquid crystal display device, comprising:
a timing controller for generating image data;
a reference voltage generator for generating a reference voltage group;
a plurality of voltage dividers, each voltage divider being capable of dividing the reference voltage group into a respective level voltage group;
a plurality of converters for converting the image data into a plurality of data signal voltages on the basis of the level voltage groups; and
a liquid crystal panel having a plurality of pixel units, each pixel unit being capable of showing various grey levels based on the data signal voltages.

2. The liquid crystal display device of claim 1, wherein the plurality of converters comprise a plurality of digital-to-analog converters.

3. The liquid crystal display device of claim 1, further comprising a source driver, wherein the plurality of voltage dividers and the plurality of converters are integrated within the source driver.

4. The liquid crystal display device of claim 1, wherein each voltage divider consists of a plurality of resistors connected in serial.

5. The liquid crystal display device of claim 1 further comprising a multiplexer, wherein the plurality of converters comprise a plurality of first polarity digital-to-analog converters and a plurality of second polarity digital-to-analog converters, and the multiplexers switch to output the data signal voltages from the first polarity digital-to-analog converters or the second polarity digital-to-analog converters based on a polarity signal.

6. A liquid crystal display device, comprising:
a timing controller for generating image data;
a plurality of reference voltage generators for generating a plurality of reference voltage groups;
a voltage divider for dividing the plurality reference voltage groups into a plurality of level voltage groups;
a plurality of converters for converting the image data into a plurality of data signal voltages on the basis of the plurality of level voltage groups; and
a liquid crystal panel having a plurality of pixel units, each pixel unit being capable of showing various grey levels based on the data signal voltages.

7. The liquid crystal display device of claim 6, wherein the plurality of converters comprise a plurality of digital-to-analog converters.

8. The liquid crystal display device of claim 6, further comprising a source driver, wherein the plurality of voltage dividers and the plurality of converters are integrated within the source driver.

9. The liquid crystal display device of claim 6, wherein each voltage divider consists of a plurality of resistors connected in serial.

10. The liquid crystal display device of claim 6 further comprising a multiplexer, wherein the plurality of converters comprise a plurality of first polarity digital-to-analog converters and a plurality of second polarity digital-to-analog converters, the multiplexers switches to output the data signal voltages from the first polarity digital-to-analog converters or the second polarity digital-to-analog converters based on a polarity signal.

11. A liquid crystal display device, comprising:
a reference voltage generator for generating a reference voltage group;
a memory for storing a plurality of lookup tables, each lookup table being capable of recording a respective relationship between the digital image data and a shift image data;
a control unit for converting the image data into the plurality of shift image data based on the plurality of lookup tables;
a plurality of converters for converting the plurality of shift image data into a plurality of data signal voltages on the basis of the reference voltage group; and
a liquid crystal panel having a plurality of pixel units, each pixel unit for showing various grey levels based on the data signal voltages.

12. The liquid crystal display device of claim 11 further comprising a timing controller, wherein the memory and the control unit are integrated within the timing controller.

13. The liquid crystal display device of claim 11 further comprising a multiplexer, wherein the plurality of converters comprise a plurality of first polarity digital-to-analog converters and a plurality of second polarity digital-to-analog converters, the multiplexers switches to output the data signal voltages from the first polarity digital-to-analog converters or the second polarity digital-to-analog converters based on a polarity signal.
